(19) United States
(12) Patent Application Publication
(10) Pub. No.: US 2005/0280342 A1
(43) Pub. Date: Dec. 22, 2005

(54) Orange and NIR-absorbing optical adhesives for plasma displays

(76) Inventor: Robert P. Wenz, Austin, TX (US)

Correspondence Address: DISPLAYTIP, LLC, 107 RR 620 SOUTH, SUITE 102A3, AUSTIN, TX, 78734, US

(21) Appl. No.: 10/873,545

(22) Filed: Jun. 22, 2004

(51) Int. Cl. H01J 17/49

(52) U.S. Cl. 313/112; 313/582

(57) ABSTRACT

The present invention is a tinted, optical adhesive for use in making plasma display filters comprising a substantially acid free, pressure-sensitive adhesive (PSA) containing a narrow-band, visible spectrum dye (e.g. less than 30 nm bandwidth) and a broader-band, near infra-red spectrum dye (e.g. greater than 200 nm), the second dye providing enhanced thermal stability as well as near infra-red (NIR) blocking. Further, acid-free adhesives offer improved stability of light control dyes. In the present invention, porphyrin-based dyes combined with acrylate-based, pressure-sensitive optical adhesives are preferred. Invention offers reduced number of functional layers in an optical filter structure as well as reduced number of manufacturing (lamination) steps in the optical filter/plasma display assembly process.

### BACKGROUND OF THE INVENTION

1. Field of the Invention

The present invention relates generally to tinted optical adhesives, and more specifically, it relates to orange and NIR (near infra-red) absorbing optical adhesives which can be used in the assembly of plasma displays to improve the performance, reduce the number of assembly steps, and lower the cost to manufacture plasma displays.

2. Description of the Prior Art

Tinted optical films are used in the information display industry to control the properties of light emitted and/or reflected from displays. These “light control” films are made from a variety of optically-clear polymers and include a pigment material or molecular dye to selectively absorb/remove a portion of the display's light spectrum to achieve a white balance, remove reflected light, or otherwise improve the displayed image's appearance. Pigments (particles, e.g. carbon black) are more desirable because dyes tend to change color hue or saturation over time due to degradation by heat during curing of the polymer, by ultra-violet light during curing or during use either from the display backlight itself or from the ambient lighting (e.g. sunlight).

Dyes also suffer from degradation due to chemical reactions with polymer additives that oxidize or reduce the dye molecules and cause color changes. This is especially true for optical adhesives where acid or base chemistry is commonly used to achieve the desired adhesive properties such as tack, adhesion, and shear properties.

To absorb specific colors, or wavelength bands, pigments or dyes have been incorporated into polymer films making a tinted, polymeric film that can be used as a color correcting or compensating film in display applications, as described in U.S. Pat. No. 6,229,252. These polymer films absorb over a relatively wide band of wavelength with the result that some of the light from the display in the wanted wavelengths is also inadvertently absorbed by the polymer film filter (e.g. a blue absorber will absorb some green light, but the overall effect is that the greater blue absorption shifts the color of the display and accomplishes the desired color correction at the expense of reduced brightness.)

Thus, a major problem in making the optical filter for plasma displays has been that absorbing pigments and dyes used in the past caused an overall reduction in brightness of the display due to wider than needed absorption bands.

Another problem with prior art is that dyes tend to fade and/or experience a shift in center wavelength when thermally processed, exposed to ultraviolet (UV) light, or exposed to an acidic or basic chemical environment. These “instabilities” make dyes undesirable as light absorbers in adhesives, since most adhesives, especially the optically-clear adhesives, are either thermally cured, UV cured, or incorporate acid or base chemistry.

Another problem with current plasma display filter technology is the large number of lamination steps used to assemble a multi-film component filter. This increases assembly costs, reduces yield, and results in a low level of light transmission. What's needed is a way to reduce the number of film layers and thereby reduce the overall number of lamination steps.

Another problem with conventional plasma display filter technology is that the optical filter transmits too much “orange” light, characteristic of the strong orange emission from the neon gas used in plasma display panels (PDPs). This excess orange emission results in a white imbalance, i.e. white scenes, such as winter snow scenes, appear slightly orange-tinted when viewed side by side with the whiter white scene of an LCD display or someone wearing a pure white shirt.

In these respects, the orange and NIR-absorbing optical adhesives for plasma displays according to the present invention substantially depart from the conventional concepts and designs of the prior art, and in so doing provides a stable, dye-tinted optical adhesives primarily developed for the purpose of reducing unwanted orange and NIR emission from plasma displays while reducing the number of layer components used to assemble a plasma display filter thereby reducing the number of assembly steps, layer components and overall assembly cost and improving the manufacturability of optical filters for plasma displays.

### SUMMARY OF THE INVENTION

In view of the foregoing disadvantages inherent in the prior art, the present invention provides new, orange and NIR-absorbing optical adhesives for plasma displays wherein the same can be utilized for improving the performance and manufacturability of optical filters for plasma displays.

To attain this, the present invention generally comprises a tinted optical adhesive for use in fabricating optical elements, including optical filters as used in plasma displays. The present invention includes an optical adhesive, preferably a pressure-sensitive adhesive (PSA), and a light-absorbing dye. PSAs offer ease of manufacturability since they can be readily applied in a roll-to-roll lamination process. PSAs also offer precise control of the laminating adhesive thickness resulting in high quality displays with good appearance to the viewer. However, in providing good adhesion properties optical PSAs have some acid or base content or otherwise non-neutral pH character. This non-neutral pH environment causes dye instability and poor durability at elevated temperatures. Experiments carried out in our laboratory have shown that the porphyrin-based dyes in a typical, acidic-type acrylic PSA provide strong, narrow band absorption (e.g. 50% or more of the light in a 20 nm wide band at 590 nm) at very low concentration, e.g. few milligrams per square foot, but lose substantially all of their strong absorption (i.e. “fade ”) after just 72 hours at 80 degrees centigrade. When the same dye is placed in an acid-free acrylic PSA, the absorption band reduces only slightly, e.g. 2%, after 500 hours at 80 C. This anti-fade property in a pH neutral PSA is very desirable for plasma displays since elevated temperature performance is required, forcing many plasma display manufacturers to use pigments rather than narrow-band dyes in optical filters. Furthermore, some manufacturers have requested performance to 120 C for 500 hours. Experiments in our laboratory have shown that even porphyrin-based dyes in pH neutral PSA will fade at 120 C. We have discovered that the combination of an NIR dye with the visible, narrow-band dye all in the same PSA is stable against fading of the visible absorption band at elevated temperatures above 80 C. This discovery is unexpected and enables one to take advantage of the better color performance offered by organic dyes. Dyes are preferred as light absorbers due to the better color quality achievable using dyes but dye stability at elevated temperature has been a problem. The current discovery now enables the use of narrow band absorbing dyes in color correction films for displays, especially plasma displays which are hampered by extraneous orange and near infra red light emission. Thus, for the present invention it is preferred to use a near neutral pH PSA, preferably an acrylic PSA, in combination with narrow-band visible and a broader-band NIR absorbing dye to achieve a stable, color correction optical adhesive for plasma displays. Other adhesive candidates include thermal, chemical, photo (UV) or other type energy-curable epoxies, silicones, acrylates, epoxy-acrylates, and other optically-clear adhesive chemistries known in the art.

For tinting, narrow-band dyes (e.g. less than 50 nm bandwidth) are preferred for use in the visible portion of the spectrum (400-700 nm) since the narrower the dye's absorptivity in the visible portion of the spectrum, the more (wanted) visible light is transmitted providing a brighter display. In the near infra red region of the spectrum, broader band dyes (e.g. greater than 200 nm) are preferred since the purpose of the NIR dye is to remove interfering NIR in the 800-1000 nm band coming from plasma displays and interfering with other electronic appliances in the same room, all of which use infra-red sensing in this near infra red band for remote control of appliance functions.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide thermal and light stable orange and NIR-absorbing optical adhesives based on a synergistic composition of porphyrin-based organic dyes for plasma displays that overcome the shortcomings of the prior art optical filters.

Another object of the present invention is to provide orange and NIR-absorbing optical adhesives for plasma displays for improving the performance and manufacturability of optical filters for plasma displays.

Another object is to provide orange and NIR-absorbing optical adhesives for plasma displays that places the color absorber(s) in the optical adhesive used to laminate functional films making up the plasma display optical filter.

Another object is to provide an orange-absorbing optical adhesive for plasma displays that absorbs the unwanted orange emission from a plasma display and thereby improves display color.

Another object is to provide an NIR-absorbing optical adhesive for plasma displays that absorbs the unwanted NIR emission from a plasma display and thereby eliminate NIR interference with IR remote control electronics.

Another object is to provide orange and NIR-absorbing optical adhesives for plasma displays that minimizes the number of functional films in a plasma display filter and thereby minimize the number of adhesive lamination steps and consequently increase the overall yield in the filter lamination process.

Another object is to provide orange and NIR-absorbing optical adhesives for plasma displays that can be continuously fabricated using color tinted adhesive rolls enabled by the present invention.

Another object of the present invention is to incorporate “planar-type” (i.e. 2-dimensional) dye molecules, such as porphyrin-based organic dyes, as opposed to more generally “linear-type” dyes molecules such as those derived from indigo and the like. Although not to be bound by theory, it is believed that the 2-D dye molecule that are (randomly) oriented more or less transverse to the light path in a film will absorb more light than if it were oriented “edge-on ”, i.e. the “1-D” edge. Thus, it is preferred that a planar-type dye molecule be used, and even further be enhanced by being oriented more or less transverse to the light path in the application. One way to do this is to incorporate, flat nanosize platforms onto which the planar molecule will attach and then orient these nano platforms in the polymer matrix using a coupling force such as electric field, magnetic field, or shear/flow fields.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference patterns designate the same or similar parts throughout the several views.

FIG. 1. Cross-sectional view showing the typical layer structure of prior art, conventional, commercial filters used on plasma displays.

FIG. 2. The present invention, a tinted, optical PSA in sheet form between two release films.

FIG. 3. One version of a layer structure using present invention optical adhesive in an optical filter mounted on the front of a plasma display.

FIG. 4. A version of a layer structure using present invention optical adhesive in a direct-mount, “film” filter mounted directly onto the front of a plasma display.

FIG. 5. Porphyrin molecule used in organic dyes for use in narrow-band, tinted optical adhesives.

FIG. 6. Optical transmission measured for an optical adhesive containing 4 grams/sq ft of porphyrin type organic dye resulting in very narrow band absorption of “neon orange” emission at 585 nm.

FIG. 7. Visible and near infra-red transmission measured for an optical adhesive containing 7 grams/sq ft of porphyrin type organic dye resulting in 95% reduction of the NIR emission from a plasma display in the range 800 nm-1000 nm.

FIG. 8. Light transmission measured for an optical adhesive containing both Orange-cutting and NIR-cutting organic dyes providing reduction of both unwanted orange light and NIR emissions from a plasma display.

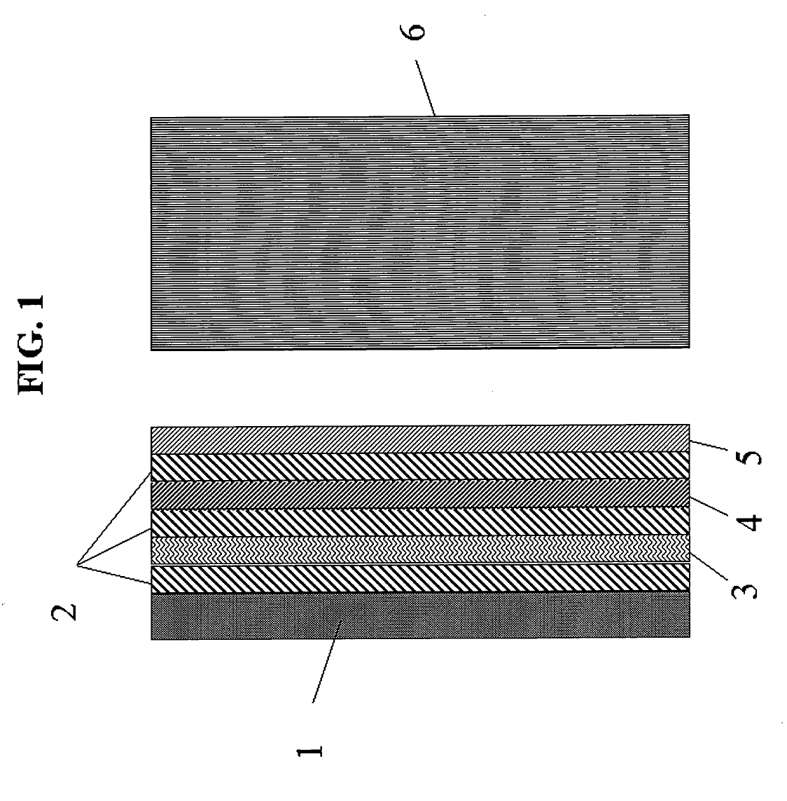

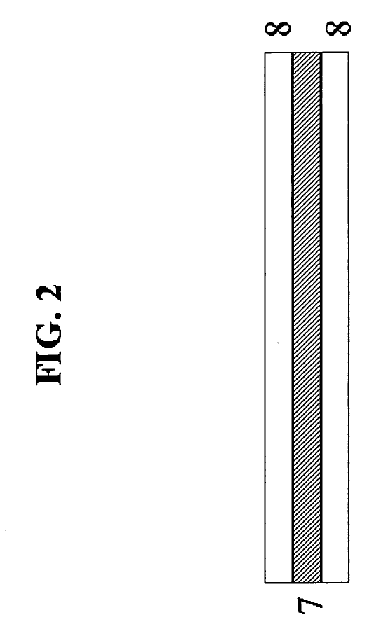

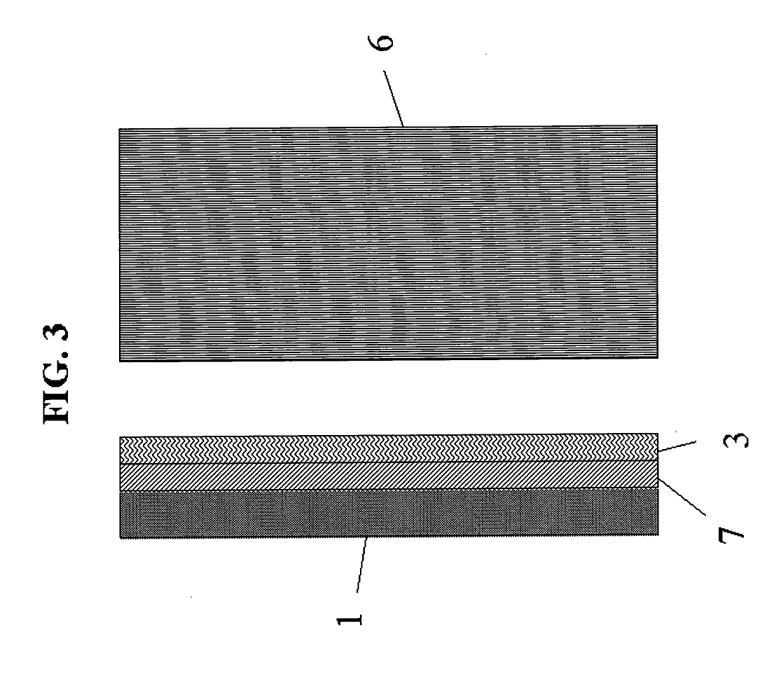

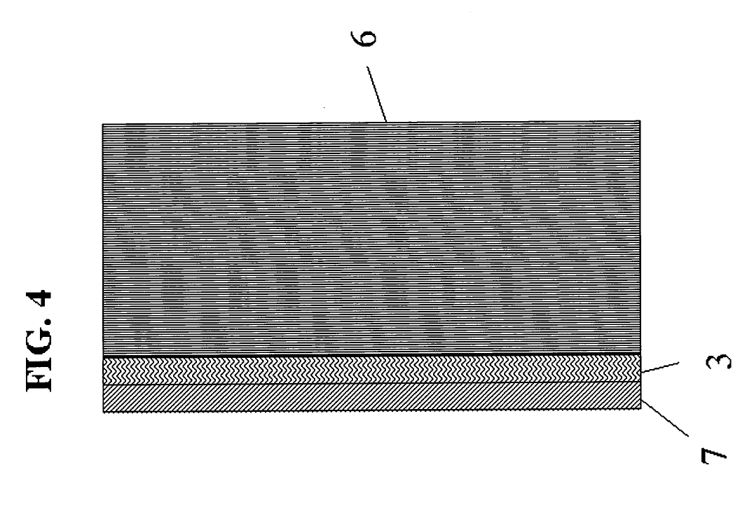

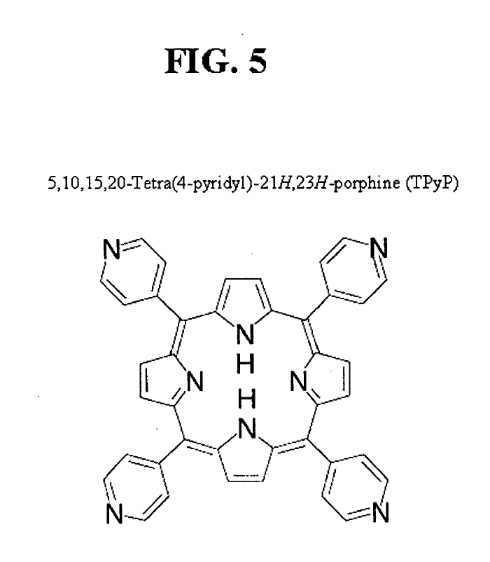

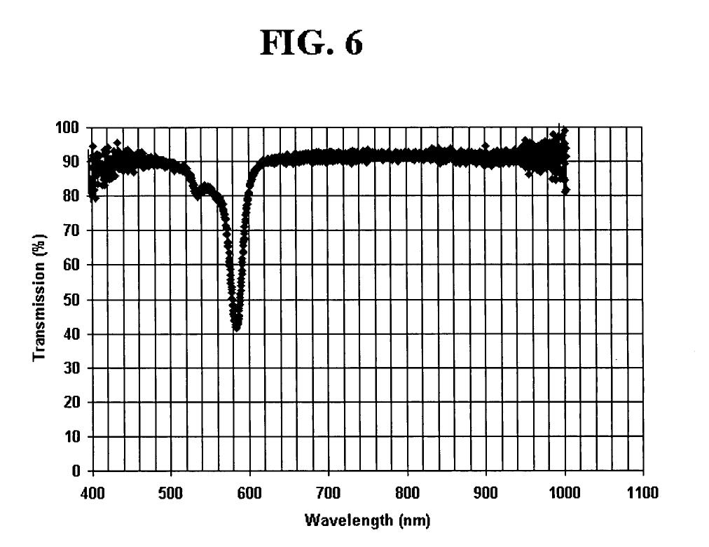

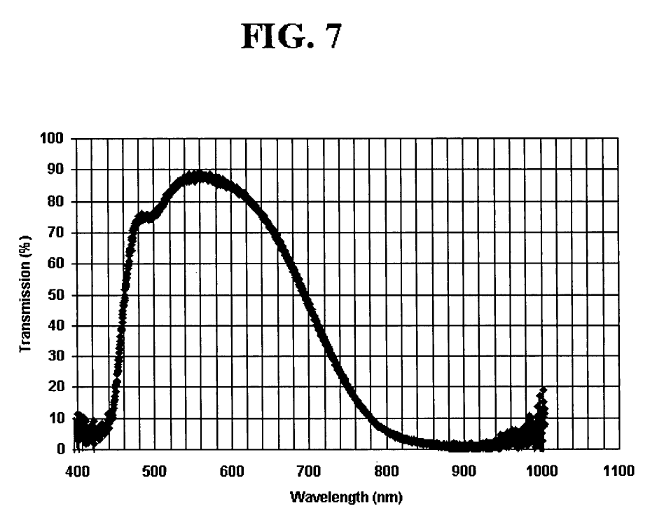

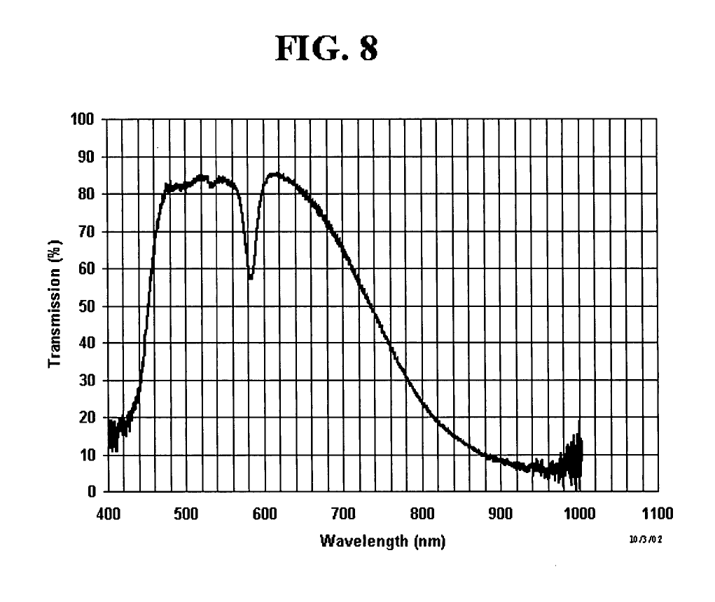

FIG. 1 shows a typical layer structure of a conventional, commercial optical filter mounted on the front of a plasma display, wherein said optical filter has several functional film layers laminated to a glass substrate 1 using multiple, optically clear adhesives 2. Functional films include an electromagnetic interference (EMI) blocking film 3, a near infra red (NIR) absorbing film 4, and an orange-absorbing film 5. This glass filter laminate is mounted on the front side of a plasma display 6 to provide EMI blocking, NIR reduction, and orange light control. FIG. 2 shows the present invention in one of its embodiments wherein the light control film is a near neutral pH optical adhesive containing an orange light absorbing dye and an NIR absorbing dye, said adhesive product provided in roll or sheet form as a controlled caliper film, typically 1 to 2 thousands of an inch thick, between two release liner films 8, such as polyester or polyethylene liner materials commonly used in the optical film industry. FIG. 3 shows the orange cut/NIR optical adhesive of the present invention combined with an EMI blocking film 7 allowing the reduction of the number of lamination steps in the production of a plasma display filter. FIG. 4 shows the preferred product application where the orange cut/NIR optical adhesive is used to directly laminate an EMI blocking film to the front screen of the plasma display, thus greatly reducing the number of lamination steps used in production and also providing a very thin, lightweight filter. FIG. 5 shows the planar structure typical of one type of porphyrin molecule. FIG. 6 shows the narrow band absorption characteristic of the orange absorber dyed adhesive of the present invention. FIG. 7 shows the NIR absorption characteristic of the NIR dyed adhesive of the present invention. FIG. 8 shows the orange/NIR characteristic of the combined orange/NIR dyed adhesive of the present invention.

### DESCRIPTION OF THE PREFERRED EMBODIMENT

Turning now descriptively to the drawings, in which similar reference characters denote similar elements throughout the several views, the attached figures illustrate a orange and NIR-absorbing optical adhesive for plasma displays, which comprises a tinted optical adhesive for use in fabricating optical elements, including optical filters as used in plasma displays. A typical layer structure of the optical filter, sometimes referred to as a “front filter”, and the plasma display is shown in FIG. 1.

The optical filter in the present invention is simpler in that fewer layers are needed because the color correcting dyes (or pigments) are contained in the laminating adhesive(s). The present invention includes an optical adhesive containing a light-absorbing dye. The adhesive is commonly a pressure-sensitive adhesive (PSA) based on neutral pH chemistry, and may be acrylate-based chemistry. Typically, an optical PSA is provided in roll or sheet form between two release films as shown in FIG. 2. For the light-absorber, narrow-band dyes (e.g. less than 100 nm bandwidth) are preferred for use in the visible portion of the spectrum (400-700 nm) since the narrower the dye's absorbtion, the more (wanted) visible light is transmitted providing a brighter display. In the NIR, broader band dyes (e.g. greater than 200 nm) are preferred since the purpose of the NIR dye is to remove interfering NIR in the 800-1000 nm band.

The most common, and most desired for its adhesive properties, optically-clear adhesive used in display applications is composed of acrylate monomers mixed with 1%-10% acrylic acid (AA) and a curing agent (commonly, a UV or heat activator). The AA controls fundamental adhesive properties, such as “tack”, shear adhesion, and other beneficial properties.

We have found though that the presence of acid (or base) chemistry in the PSA causes incorporated dyes to fade. We have further discovered that use of a class of optically-clear adhesives having little or no acid content minimizes or eliminates fading of dyed PSA made therefrom. Furthermore, we have selected very narrow band dyes (e.g. <50 nm FWHM) to minimize unwanted absorption in neighboring color bands (e.g. green and red next to orange, in the case of our orange absorbing PSA) and thereby provide maximum brightness of the display incorporating our tinted PSA.

Although not to be bound by theory of any sort, it is believed that planar type (i.e. 2-dimensional) dyes, such as those found in the porphyrin family of dyes as shown in FIG. 5, offer the greatest amount of light absorption while using very little dye mixed into the adhesive. Further, it has been found that these dyes provide the very narrow-band absorption desired, as shown in FIG. 6.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An optical filter for color enhancement of a plasma display comprising:
an organic dye having an absorbance peak in the range of 550-610 nm,
said dye distributed in a substantially acid-free, optically-clear adhesive.

2. The optical filter of claim 1, wherein the organic dye is derived from a porphyrin molecule.

3. The optical filter of claim 1, wherein the organic dye comprises about 2-8 mg/ft2 of porphyrin-based dye(A) having the transmission characteristic of FIG. 6.

4. The optical filter of claim 1, wherein the acid-free, optically-clear adhesive is an acrylic adhesive, a silicone adhesive, or an epoxy adhesive.

5. An optical bandpass filter for reducing infrared emission from a plasma display comprising:
a dye having an absorbance band predominantly above 800 nm extending to at least 1000 nm,
said dye distributed in a substantially acid-free, optically-clear adhesive.

6. The optical filter of claim 5, wherein the organic dye comprises about 5-11 mg/ft2 of porphyrin-based dye(B) having the transmission characteristic of FIG. 7.

7. An optical filter for enhancing color and reducing infrared emission in a plasma display comprising:
a porphyrin-based dye having an absorbance peak in the range of 550-610 nm,
a dye or pigment having an absorbance band predominantly in the range 800-1000 nm,
both components being distributed in a substantially acid-free, optically-clear adhesive.

8. The optical filter of claim 7, wherein the combination of a dye (A) and a dye (B) provides an optical filter with a transmission characteristic similar to that of FIG. 8.

9. A plasma display device comprising:
a face plate having an inner surface and an outer surface, the inner surface containing a phosphor layer;
a transparent filter formed over the outer surface of the face plate; said filter comprising:
an organic dye (A) having an absorbance peak in the range of 550-610 nm,
a dye or pigment (B) having an absorbance band predominantly in the range of 800-1000 nm,
said dye (s) and pigment are distributed in a single, optically-clear adhesive.

10. The optical filter of claim 9, wherein the dye comprises about 2-8 mg/ft2 of porphyrin-based dye(A) having the transmission characteristic of FIG. 6 and the dye (B) comprises about 5-11 mg/ft2 of porphyrin-based dye(B) having the transmission characteristic of FIG. 7.

11. A bandpass filter for color enhancement of a plasma display comprising:
a porphyrin dye (A) having an absorbance peak in the range of 570-610 nm,
a porphyrin dye (B) having substantially an absorbance band in the range of 800-1000 nm,
both dyes incorporated in a polymeric or adhesive matrix as part of a laminate structure, wherein dye (A) comprises about 2 mg/ft2 to about 6 mg/ft2 in the final, filter laminate structure, dye (B) comprises about 4 mg/ft2 to about 10 mg/ft2 in the final, filter laminate structure.

12. An optical film filter for direct lamination to the front surface of a plasma display comprising:
a substantially neutral pH, optically-clear adhesive containing an organic dye having an absorbance peak in the range of 550-610 nm and having less than 30 FWHM peak width, and a second organic dye or dye combination having an absorbance band in the range of 800-1000 nm, and
a conductive, transparent EMI blocking film having less than 0.5 ohm/sq electrical sheet resistance and greater than 40% transmission in the visible portion of the spectrum.
